(19) United States
(12) Patent Application Publication
(10) Pub. No.: US 2010/0162237 A1
(43) Pub. Date: Jun. 24, 2010

(54) NETWORK ADMINISTRATION IN A VIRTUAL MACHINE ENVIRONMENT THROUGH A TEMPORARY POOL

(75) Inventors: Raghavendra Babu B R, Bangalore (IN); Arun Kumar BHASKAR, Bangalore (IN); Sivaprasad K GOVINDANKUTTY, Bangalore (IN)

Correspondence Address: VMWARE, INC., DARRYL SMITH, 3401 Hillview Ave., PALO ALTO, CA, 94304, US

(73) Assignee: VMWARE, INC., Palo Alto, CA (US)

(21) Appl. No.: 12/342,154

(22) Filed: Dec. 23, 2008

(51) Int. Cl. G06F 9/455

(52) U.S. Cl. 718/1

(57) ABSTRACT

A method, apparatus, and system of network administration in a virtual machine environment through a temporary pool are disclosed. In one embodiment, a method includes determining that a desktop source requires maintenance, creating a temporary pool, accessing the desktop source requiring maintenance, automatically transferring the desktop source requiring maintenance from a source pool to the temporary pool, determining that an issue with the desktop source transferred to the temporary pool is rectified and automatically transferring the desktop source from the temporary pool to the source pool when the issue is rectified.

### RELATED APPLICATIONS

This application is related to U.S. application Ser. No. ______ (Docket No. A307), entitled “Policy Management to Initiate an Automated Action on a Desktop Source” and U.S. application Ser. No. ______ (Docket No. A301), entitled “Desktop Source Transfer Between Different Pools.”

### FIELD OF TECHNOLOGY

This disclosure relates generally to an enterprise method, a technical field of software and/or hardware technology and, in one example embodiment, to network administration in a virtual machine environment through a temporary pool.

### BACKGROUND

When a desktop source (e.g., a virtual machine, a blade server, or a physical system associated with a user and an operating system) is corrupted and/or needs maintenance, a third-party (e.g., a support professional) may need to access the desktop source. The third-party may provide technical support in a virtual machine environment. The virtual machine environment may include a number of groupings of desktop sources called pools.

The desktop source that is corrupted and/or needs maintenance may be included in a pool that comprises of other desktop sources which are not corrupted. The third-party may need to access the desktop source that is corrupted and/or needs maintenance to rectify a problem with the desktop source that is corrupted and/or needs maintenance. A technology limitation may require that the third-party be granted access to all desktop sources in the pool (e.g., including the desktop source that is corrupted and/or needs maintenance and the other desktop sources which are not corrupted) to rectify the problem. As a result, confidential information on the other desktop sources which are not corrupted may be exposed to the third party. Therefore, security of the virtual machine environment may be compromised.

### SUMMARY

In one aspect, a machine-readable medium embodying a set of instructions that, when executed by a machine, causes the machine to perform a method includes determining that a desktop source requires maintenance. In addition, the machine-readable medium may include creating a temporary pool. The machine-readable medium may also include accessing the desktop source requiring maintenance. The machine-readable medium may include automatically transferring the desktop source requiring maintenance from a source pool to the temporary pool. In addition, the machine-readable medium may include determining that an issue with the desktop source transferred to the temporary pool is rectified. The machine-readable medium may also include automatically transferring the desktop source from the temporary pool to the source pool when the issue is rectified.

In another aspect, a system includes a virtual machine server of a data center that hosts a desktop source requiring maintenance. In addition, the system includes a connection server to create a temporary pool, to automatically transfer the desktop source requiring maintenance from a source pool on the connection server to the temporary pool, and to automatically transfer the desktop source from the temporary pool to the source pool when an issue in the desktop source requiring maintenance is rectified. The system may also include a set of client devices to access the rectified desktop source through the connection server.

In yet another aspect, a machine-readable medium embodying a set of instructions that, when executed by a machine, causes the machine to perform a method includes forming a temporary pool having a plurality of desktop sources requiring maintenance provided to the temporary pool from different source pools. In addition, the machine-readable medium may include permitting a support professional to access to the temporary pool. The machine-readable medium may also include restricting access by the support professional to the different source pools having desktop sources that do not require maintenance. The machine-readable medium may yet include automatically transferring the desktop sources in the temporary pool to the different source pools which provided the desktop sources to the temporary pool when the support professional rectifies an issue of the desktop sources in the temporary pool.

### BRIEF DESCRIPTION OF THE DRAWINGS

FIG. 1 is system view illustrating communication between client devices with pools from a connection server administrator through a network, according to one or more embodiment.

FIG. 2A is a process flow illustrating maintenance of a desktop source of the pools, according to one or more embodiment.

FIG. 2B is a continuation of process flow of FIG. 2A illustrating additional operations, according to one or more embodiment.

FIG. 2C is a continuation of process flow of FIG. 2B illustrating additional operations, according to one or more embodiment.

FIG. 3A is a flow chart illustrating a process of maintenance of a desktop source taken into the temporary pool from the pools, according to one or more embodiment.

FIG. 3B is a continuation of flow chart of FIG. 3A, illustrating additional operations, according to one embodiment.

FIG. 4 is a flow chart illustrating a desktop source restoration operation, according to one or more embodiment.

### DETAILED DESCRIPTION

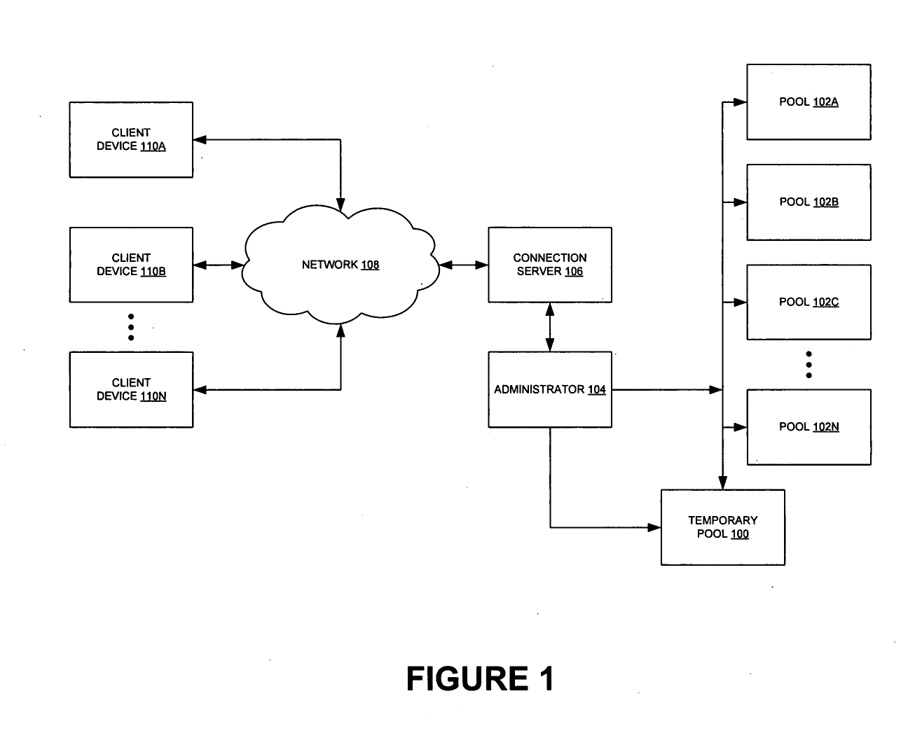

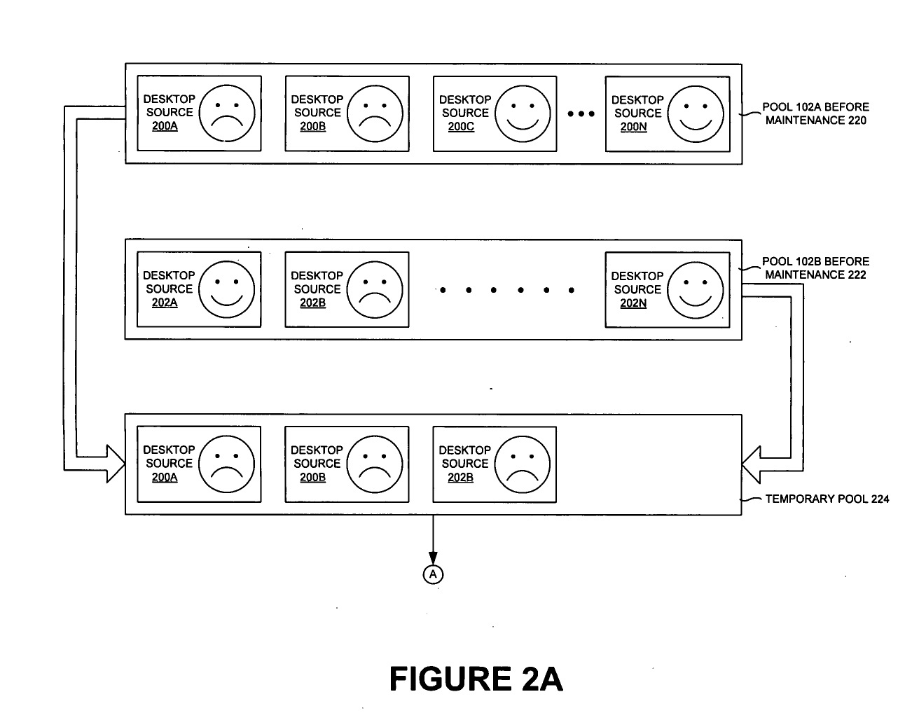

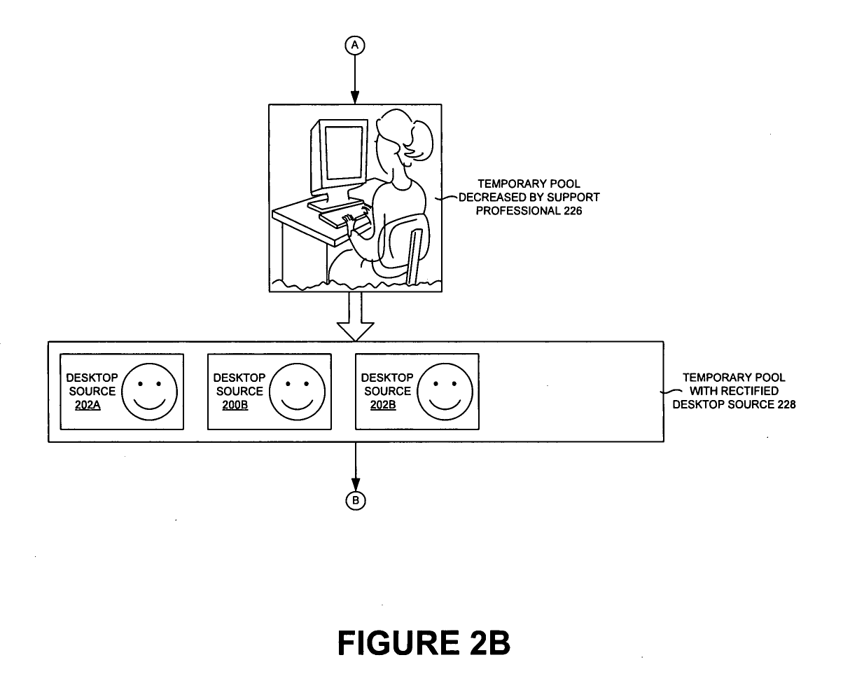

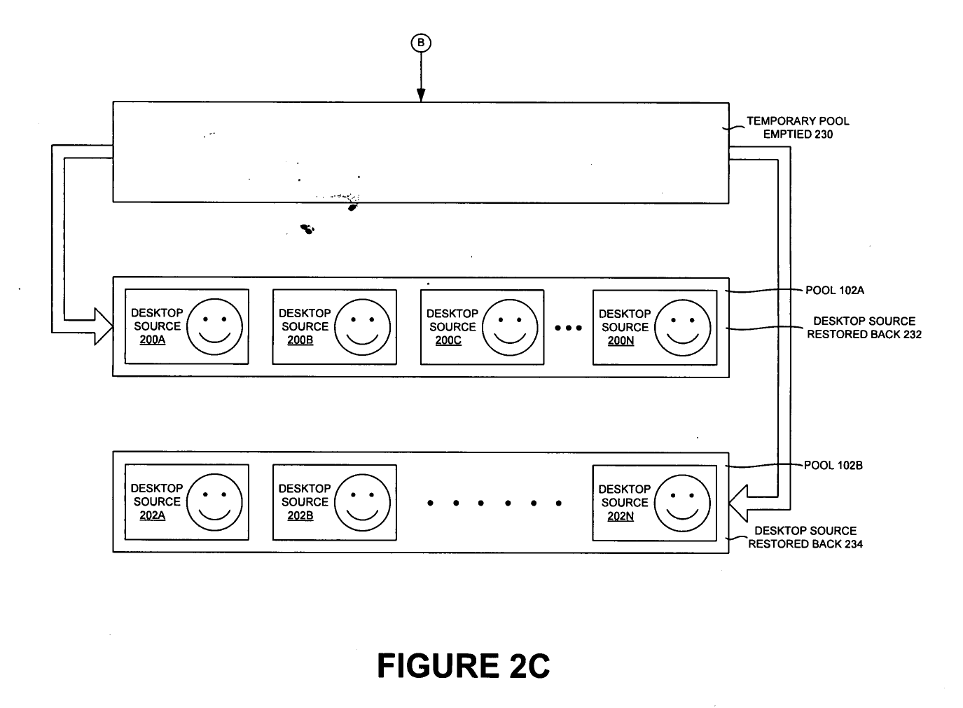

In one embodiment, a machine-readable medium embodying a set of instructions that, when executed by a machine, causes the machine to perform a method includes determining a desktop source (e.g., the desktop source 200A-B, 202B of FIG. 2) that requires maintenance, creating a temporary pool (e.g., the temporary pool 100 of FIG. 1), accessing the desktop source 200A-B, 202B that requires maintenance, automatically transferring the desktop source 200A-B, 202B requiring maintenance from a source pool (e.g., the pools 102A-N of FIG. 1) to the temporary pool 100, determining that an issue with the desktop source 200A-B, 202B transferred to the temporary pool 100 is rectified and automatically transferring the desktop source 200A-B, 202B from the temporary pool 100 to the source pool 102A-N when the issue is rectified.

In another embodiment, a system includes a virtual machine server of a data center that hosts a desktop source (e.g., the desktop source 200A-B, 202B of FIG. 2) requiring maintenance, a connection server (e.g., the connection server 106 of FIG. 1) to create a temporary pool (e.g., the temporary pool 100 of FIG. 1), to automatically transfer the desktop source 200A-B, 202B requiring maintenance from a source pool (e.g., the pool 102A-N of FIG. 1) on the connection server 106 to the temporary pool 100 and to automatically transfer the desktop source (e.g., the pool 102A-N of FIG. 1) from the temporary pool 100 to the source pool 102A-N when an issue in the desktop source 200A-N requiring maintenance is rectified and a set of client devices (e.g., the set of client devices 110A-N) to access the rectified desktop source through the connection server 106.

In yet another embodiment, a machine-readable medium embodying a set of instructions that, when executed by a machine, causes the machine to perform a method includes forming a temporary pool (e.g., the temporary pool 100 of FIG. 1) having desktop sources (e.g., the desktop source 200A-B, 202B of FIG. 2) requiring maintenance provided to the temporary pool 100 from different source pools (e.g., the pools 102A-N of FIG. 1), permitting a support professional (e.g., network administrator, troubleshooting professionals, etc.) to access to the temporary pool 100, restricting access by the support professional to the different source pools 102A-N having desktop sources 200C-N, 202A,C-N that do not require maintenance, and automatically transferring the desktop sources 200A-B, 202B in the temporary pool 100 to the different source pools 102A-N which provided the desktop sources 200A-B, 202B to the temporary pool 100 when the support professional rectifies an issue of the desktop sources 200A-B, 202B in the temporary pool 100.

FIG. 1 is system view illustrating communication between client devices with pools from a connection server administrator through a network, according to one or more embodiment.

In a virtual environment, a data center may have a virtual machine server. The data center may host a pool that includes desktop sources. Pools 102A-N may be a group of desktop sources which may be assigned to the end user (e.g., the client device 108A-N). There may be several kinds of management of the pools based on enterprise requirements, some of them are individual desktop, manual desktop pool, automated desktop pool, terminal server pool, etc. There may be chances that a desktop source200A-B, 202B in the pool may require maintenance due to various reasons (e.g., resource sharing, conflicts, software problems, etc.). The desktop source 200A-B, 202B that requires maintenance may be moved to the temporary pool. The desktop source requiring maintenance may be restored by an administrator 104. The administrator 104 may be a professional who manages the restoration, troubleshooting, resource management, etc. of the desktop sources in the data center.

In one embodiment, the desktop sources may be transferred from different source pools 102A-N to the temporary pool 100. The desktop sources may have resided on different virtual machine servers prior to being transferred to the temporary pool 100. The issue may be common to the desktop sources residing in the temporary pool 100. The issue may be of an operating system issue, a configuration issue, an application issue, a patch update issue, a system crash issue, a software installation issue, and/or a technical support issue. The source pool 102A-N may be a grouping of virtual machines sharing a common attribute. The common attribute may be an organization, a functional role, an application configuration, and/or the operating system. The connection server 106 may create the temporary pool 100, to automatically transfer the desktop source requiring maintenance from a source pool 102A-N on the connection server 106 to the temporary pool 100, and to automatically transfer the desktop source from the temporary pool 100 to the source pool 102A-N when an issue in the desktop source requiring maintenance is rectified. The set of client devices 110A-N may access the rectified desktop source through the connection server 106.

The issue may be an operating system issue, a configuration issue, an application issue, a patch update issue, a system crash issue, a software installation issue, and/or a technical support issue. The temporary pool 100 may be formed having desktop sources requiring maintenance provided to the temporary pool 100 from different source pools 102A-N. A support professional may be permitted to access to the temporary pool 100. Access may be restricted by the support professional to the different source pools 102A-N having desktop sources that do not require maintenance. The desktop sources may be automatically transferred in the temporary pool 100 to the different source pools 102A-N which provided the desktop sources to the temporary pool 100 when the support professional rectifies an issue of the desktop sources in the temporary pool 100.

The administrator 104 may be accessible from a remote location through a web browser and can perform various activities like pool management, configuration changes, manage entitlements, rights and policies, etc. A client device 108A-N may be a windows client, a linux web access, a MAC web access, a thin client that may access the desktop source in the data center of the virtual environment. The client devices 110A-N may access the desktop resources based on requirements from the connection server 106. The connection server 106 may enable the authorized end-users (e.g., the client device 108A-N) to securely connect to the centralized virtual desktop, back-end physical systems and/or the terminal servers in the datacenter. The client devices 110A-N may access the connection server 106 through the network 108.

FIG. 2A is a process flow illustrating maintenance of a desktop source of the pools, according to one or more embodiment. Particularly, FIG. 2A-C is an example embodiment of FIG. 1. In operation 220, the pool 102A before maintenance may have the desktop sources 100A-N. The desktop source 200A of the pool 102A in particular may require maintenance due to various factors. In operation 222, the pool 102B before maintenance may have the desktop sources 202A-N. In particular, the desktop source 202B of the pool 102B may require maintenance. The desktop sources which may require maintenance (e.g., the desktop sources 200A-B, 202B, etc.) may be moved to the temporary pool 100 for maintenance and restoration in operation 224.

FIG. 2B is a continuation of process flow of FIG. 2A illustrating additional operations, according to one or more embodiment. The temporary pool 100 may have the desktop source that requires maintenance. The support professional may have access to the temporary pool 100 for maintenance and restoration of the desktops sources which requires maintenance. The desktop sources may be rectified in the temporary pool 100 by the support professional. In operation 226, the support professional decreases the temporary pool 100 by restoring the desktop resources. In operation 228, the temporary pool may have rectified desktop resources.

FIG. 2C is a continuation of process flow of FIG. 2B illustrating additional operations, according to one or more embodiment. In operation 230, the temporary pool 100 may be emptied after restoration by moving the restored desktop sources back to their origin pools. In example embodiment, the restored desktop source 200A-B may be moved back to the pool 102A in operation 232. The restored desktop source 202B may be moved to its original source pool 102B in operation 234.

In one embodiment, the desktop source 200A-B, 202B that requires maintenance may be determined. The temporary pool 100 may be created. The desktop source 200A-B, 202B may be accessed that requires maintenance. The desktop source 200A-B, 202B requiring maintenance may be automatically transferred from a source pool 102A-N to the temporary pool 100. It may be determined that an issue with the desktop source 200A-B, 202B transferred to the temporary pool 100 is rectified. The desktop source 200A-B, 202B may be automatically transferred from the temporary pool 100 to the source pool 102A-N when the issue is rectified.

A heterogeneous temporary pool may be formed from the temporary pool 100. The heterogeneous temporary pool may include desktop sources 200A-B, 202B requiring maintenance having different operating systems. Access may be provided to a support professional to the desktop sources 200A-B, 202B requiring maintenance in the temporary pool 100 while restricting access of the source pool 102A-N by the support professional. The source pool 102A-N may include desktop sources that do not require maintenance. The desktop source 200A-N, 202A-N may be a virtual machine, a physical system, and a blade server associated with a user and an operating system. A virtual machine server of a data center that may host the desktop source 200A-B, 202B requiring maintenance.

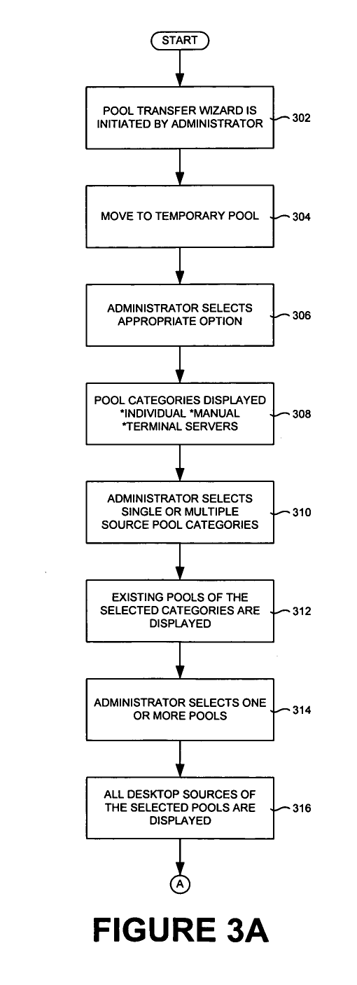

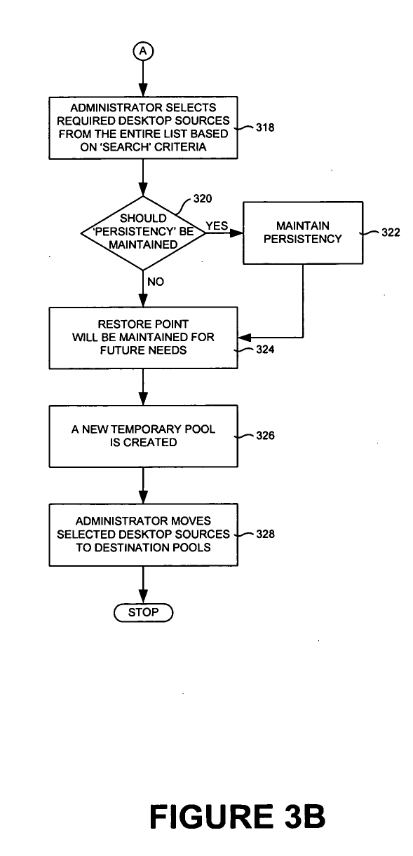

FIG. 3A is a flow chart illustrating a process of maintenance of a desktop source taken into the temporary pool from a pool, according to one or more embodiment. In operation 302, a pool transfer wizard may be initiated by administrator 104. In operation 304, the desktop source which may require maintenance may be moved to temporary pool 100. In operation 306, the administrator 104 may select an appropriate option. In operation 308, pool categories may be displayed (e.g., individual desktop, manual desktop pool, automated desktop pool, terminal server pool, etc.). In operation 310, the administrator 104 may select single or multiple source pool categories. In operation 312, the existing pools of the selected categories may be displayed. In operation 314, the administrator 104 may select one or more pools. In operation 316, all desktop sources of the selected pools may be displayed.

FIG. 3B is a continuation of flow chart of FIG. 3A, illustrating additional operations, according to one embodiment. In operation 318, the administrator 104 may select required desktop source from the entire list based on ‘search criteria’. In operation 320, a condition may be determined to check whether ‘persistency’ should be maintained. If the condition results true or yes the persistency may be maintained in operation 322 and operation 324 is initiated. In operation 324, if the condition results false or no then the restore point may be maintained for future needs. In addition, the restore point may be maintained after maintaining persistency in operation 324. In operation 326, a new temporary pool may be created. In operation 328, the administrator 104 may move selected desktop sources to the destination pools.

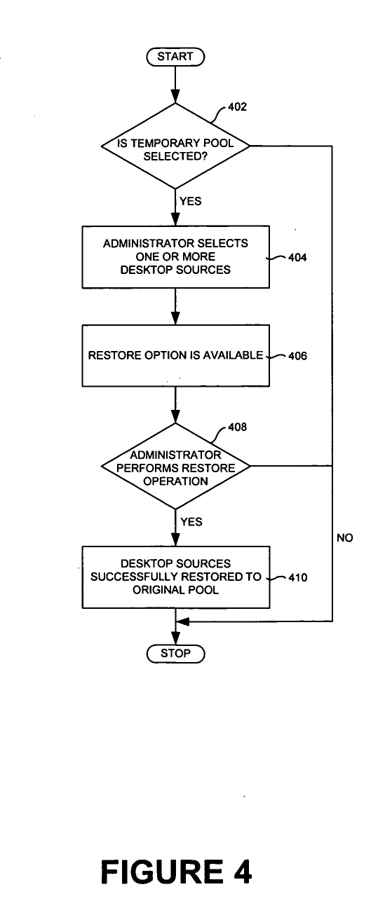

FIG. 4 is a flow chart illustrating a desktop source restoration operation, according to one or more embodiment. In operation 402, a condition may be determined to check whether a temporary pool is selected or not. If the condition evaluates to be true then operation 404 is initiated, else the process may be terminated. In operation 404, the administrator 104 may select one or more desktop sources. In operation 406, a restore operation may be made available. In operation 408, a condition may be determined for the administrator 104 to perform a restore operation. If the condition evaluates to be true then operation 410 may be initiated, else the process may be terminated. In operation 410, the desktop sources may be successfully restored to the original pool.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the connection server 106, and the network 108 of FIG. 1-4 may be enabled using a low-capacity storage circuit, an operating virtual machine circuit, a source physical server circuit, a destination physical server circuit, a local storage circuit, a destination local storage circuit, a redo log circuit, an Internet Small System Interface (iSCSI) circuit, a network circuit, a disk circuit, a NIC circuit, a memory circuit, a CPU circuit, a virtualization management server circuit, a monitoring device circuit, a storage circuit, a file system sharing circuit, a intermediary agent circuit, an operating virtual machine monitor circuit, a live migration module circuit, and other circuits.

In one or more embodiments, programming instructions for executing above described methods and systems are provided. The programming instructions are stored in a computer readable media.

With the above embodiments in mind, it should be understood that one or more embodiments of the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of one or more embodiments of the invention are useful machine operations. One or more embodiments of the invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The programming modules and software subsystems described herein can be implemented using programming languages such as Flash, JAVA™, C++, C, C#, Visual Basic, JavaScript, PHP, XML, HTML etc., or a combination of programming languages. Commonly available protocols such as SOAP/HTTP may be used in implementing interfaces between programming modules. As would be known to those skilled in the art the components and functionality described above and elsewhere herein may be implemented on any desktop operating system such as different versions of Microsoft Windows, Apple Mac, Unix/X-Windows, Linux, etc., executing in a virtualized or non-virtualized environment, using any programming language suitable for desktop software development.

The programming modules and ancillary software components, including configuration file or files, along with setup files required for providing the method and apparatus for troubleshooting subscribers on a telecommunications network and related functionality as described herein may be stored on a computer readable medium. Any computer medium such as a flash drive, a CD-ROM disk, an optical disk, a floppy disk, a hard drive, a shared drive, and storage suitable for providing downloads from connected computers, could be used for storing the programming modules and ancillary software components. It would be known to a person skilled in the art that any storage medium could be used for storing these software components so long as the storage medium can be read by a computer system.

One or more embodiments of the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

One or more embodiments of the invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

While one or more embodiments of the present invention have been described, it will be appreciated that those skilled in the art upon reading the specification and studying the drawings will realize various alterations, additions, permutations and equivalents thereof. It is therefore intended that embodiments of the present invention include all such alterations, additions, permutations, and equivalents as fall within the true spirit and scope of the invention as defined in the following claims. Thus, the scope of the invention should be defined by the claims, including the full scope of equivalents thereof.

What is claimed is:

1. A machine-readable medium embodying a set of instructions that, when executed by a machine, causes the machine to perform a method comprising
determining that a desktop source requires maintenance;
creating a temporary pool;
accessing the desktop source requiring maintenance;
automatically transferring the desktop source requiring maintenance from a source pool to the temporary pool;
determining that an issue with the desktop source transferred to the temporary pool is rectified; and
automatically transferring the desktop source from the temporary pool to the source pool when the issue is rectified.

2. The machine-readable medium of claim 1 further comprising forming a heterogeneous temporary pool from the temporary pool, wherein the heterogeneous temporary pool comprises desktop sources requiring maintenance having different operating systems.

3. The machine-readable medium of claim 2 further comprising providing access to a support professional to the desktop sources requiring maintenance in the temporary pool while restricting access of the source pool by the support professional.

4. The machine-readable medium of claim 3 wherein the source pool includes desktop sources that do not require maintenance.

5. The machine-readable medium of claim 2 further comprising transferring a plurality of desktop sources from different source pools to the temporary pool.

6. The machine-readable medium of claim 5 wherein the plurality of desktop sources resided on different virtual machine servers prior to being transferred to the temporary pool.

7. The machine-readable medium of claim 6 wherein the issue is common to the plurality of desktop sources residing in the temporary pool.

8. The machine-readable medium of wherein the issue is at least one of an operating system issue, a configuration issue, an application issue, a patch update issue, a system crash issue, a software installation issue, and a technical support issue.

9. The machine-readable medium of claim 1:
wherein the source pool is a grouping of virtual machines sharing a common attribute,
wherein the desktop source is at least one of a virtual machine, a physical system, and a blade server associated with a user and an operating system, and
wherein the common attribute is at least one of an organization, a functional role, an application configuration, and the operating system.

10. A system, comprising:
a virtual machine server of a data center that hosts a desktop source requiring maintenance;
a connection server to create a temporary pool, to automatically transfer the desktop source requiring maintenance from a source pool on the connection server to the temporary pool, and to automatically transfer the desktop source from the temporary pool to the source pool when an issue in the desktop source requiring maintenance is rectified; and
a set of client devices to access the rectified desktop source through the connection server.

11. The system of claim 10 wherein a heterogeneous temporary pool is formed from the temporary pool, wherein the heterogeneous temporary pool comprises desktop sources requiring maintenance having different operating systems.

12. The system of claim 11 wherein access is provided to a support professional to the desktop sources requiring maintenance in the temporary pool while restricting access of the source pool by the support professional.

13. The system of claim 12 wherein the source pool includes desktop sources that do not require maintenance.

14. The system of claim 11 wherein a plurality of desktop sources are transferred from different source pools on different virtual machine servers to the temporary pool.

15. The system of claim 14 wherein the issue is common to the plurality of desktop sources residing in the temporary pool.

16. The system of claim 15 wherein the issue is at least one of an operating system issue, a configuration issue, an application issue, a patch update issue, a system crash issue, a software installation issue, and a technical support issue.

17. The system of claim 10:
wherein the source pool is a grouping of virtual machines sharing a common attribute,
wherein the desktop source is at least one of a virtual machine, a physical system, and a blade server associated with a user and an operating system, and
wherein the common attribute is at least one of an organization, a functional role, an application configuration, and the operating system.

18. A machine-readable medium embodying a set of instructions that, when executed by a machine, causes the machine to perform a method comprising:
forming a temporary pool having a plurality of desktop sources requiring maintenance provided to the temporary pool from different source pools;
permitting a support professional to access to the temporary pool;
restricting access by the support professional to the different source pools having desktop sources that do not require maintenance; and
automatically transferring the desktop sources in the temporary pool to the different source pools which provided the desktop sources to the temporary pool when the support professional rectifies an issue of the desktop sources in the temporary pool.

19. The machine-readable medium of claim 18 wherein a heterogeneous temporary pool is formed from the temporary pool, wherein the heterogeneous temporary pool comprises desktop sources requiring maintenance having different operating systems.

20. The machine-readable medium of claim 18 wherein the issue is at least one of an operating system issue, a configuration issue, an application issue, a patch update issue, a system crash issue, a software installation issue, and a technical support issue.
